(19) United States
(12) Patent Application Publication
(10) Pub. No.: US 2023/0269600 A1
(43) Pub. Date: Aug. 24, 2023

(54) TECHNIQUES FOR BEAM SWEEPING DURING LOOP PROCESSING IN WIRELESS COMMUNICATIONS

(71) Applicant: QUALCOMM Incorporated, San Diego, CA (US)

(72) Inventors: Jun ZHU, San Diego, CA (US); Kang GAO, San Diego, CA (US); Yong LI, San Diego, CA (US); Tae Min KIM, San Diego, CA (US); Lei XIAO, San Jose, CA (US); Raghu Narayan CHALLA, San Diego, CA (US)

(21) Appl. No.: 17/678,536

(22) Filed: Feb. 23, 2022

(51) Int. Cl. H04W 16/28; H04W 56/00; H04L 1/00

(52) U.S. Cl. CPC H04W 16/28; H04W 56/001; H04L 1/0025

(57) ABSTRACT

Aspects described herein relate to receiving, from a node and using a serving beam for loop processing, at least a first signal in a synchronization signal burst set, and receiving, from the node and using a non-serving beam for beam sweeping, at least a second signal in the synchronization signal burst set.

### BACKGROUND

Aspects of the present disclosure relate generally to wireless communication systems, and more particularly, to performing beam sweeping.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, such as 5G NR, a node communicating in a wireless network, such as a user equipment (UE), base station, etc., can beamform wireless communications by selectively powering or using antenna resources to achieve a spatial direction for a beam. For example, a UE can beamform beams using antenna resources in receiving communications from, or transmitting communications to, a base station or another UE. In addition, in wireless communication technologies such as 5G NR, a UE can manage loops for communications based on synchronization signal block beams received from a base station, such as a time tracking loop, frequency tracking loop, automatic gain control, etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to receive, from a node and using a serving beam for loop processing, at least a first signal in a synchronization signal burst set, and receive, from the node and using a non-serving beam for beam sweeping, at least a second signal in the synchronization signal burst set.

In another aspect, a method for wireless communication at a node is provided that includes receiving, from a node and using a serving beam for loop processing, at least a first signal in a synchronization signal burst set, and receiving, from the node and using a non-serving beam for beam sweeping, at least a second signal in the synchronization signal burst set.

In another aspect, an apparatus for wireless communication is provided that includes means for receiving, from a node and using a serving beam for loop processing, at least a first signal in a synchronization signal burst set, and means for receiving, from the node and using a non-serving beam for beam sweeping, at least a second signal in the synchronization signal burst set.

In another aspect, a computer-readable medium including code executable by one or more processors for wireless communications is provided. The code includes code for receiving, from a node and using a serving beam for loop processing, at least a first signal in a synchronization signal burst set, and receiving, from the node and using a non-serving beam for beam sweeping, at least a second signal in the synchronization signal burst set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a user equipment (UE) for wireless communications, in accordance with various aspects of the present disclosure;

FIG. 3 is a flow chart illustrating an example of a method for using beams received for loop processing also for performing beam sweeping, in accordance with aspects described herein;

FIG. 4 illustrates an example of a timeline for receiving a synchronization signal burst set (SSBS), in accordance with aspects described herein; and

FIG. 5 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to using beams in loop processing for additionally performing beam sweeping of multiple beams for other purposes, such as mobility tracking. For example, in wireless communication technologies such as fifth generation (5G) new radio (NR), a user equipment (UE) or other device can receive a set of signals used for loop processing. For example, these signals may be referred to as a synchronization signal block (SSB) and may include one or more of a primary synchronization signal (PSS), a secondary synchronization signal (SSS), or a primary broadcast channel (PBCH) signal. A base station, or another UE or other device, can transmit the SSB (the signals of the SSB) to the UE using a beam. For example, the base station or other transmitting device can generate the beam by selectively using or applying power to antenna elements to achieve a spatial direction for transmitting the signals. The UE receiving the SSB can similarly generate a reciprocal beam by selectively using or applying power to antenna elements to achieve a spatial direction for receiving the signals in the SSB. The UE receiving the SSB and the transmitting device may also use the beams for other subsequent communications.

In some examples, the receiving UE and transmitting device can coordinate beam selection to optimize communication quality using the beams having a nearest or most optimal spatial direction between the receiving UE and transmitting device. Using beams in millimeter wave (mmW) signaling, such as in 5G NR, can help satisfy link budget. Over time, as the UE moves or rotates relative to the transmitting device, other beams may become more optimal for the UE. As such, for example, the UE can perform mobility tracking of beams by measuring signals received from the transmitting device (e.g., signals in the SSB or other signals) using various beams at the receiving UE, including the current serving beam and one or more non-serving beams. If the receiving UE determines that a non-serving beam has more desirable properties (e.g., higher signal or quality) than the serving beam, for example, the receiving UE can switch to use the non-serving beam as the new serving beam in communicating with the base station or other transmitting device.

In addition, as described, the UE can use the SSB signals for loop processing where the receiving UE can update or otherwise manage one or more of a time tracking loop (TTL) for synchronizing timing with the transmitting device based on the signals, frequency tracking loop (FTL) for synchronizing frequency with the transmitting device based on the signals, automatic gain control (AGC) for adjusting power for communicating with the transmitting device based on the signals, etc. For example, upon each loop occasion, which may be with certain periodicity (e.g., 80 or 160 milliseconds (ms)), the receiving UE can apply the serving UE beam on PBCH/SSS symbols (three symbols in total) of serving SSB in serving cell's synchronization signal burst set (SSBS) for loop processing. Currently, the UE cannot also perform beam sweeping when using the SSBS for loop processing.

For example, the time to sweep multiple beams can cause high power consumption, as the UE can wake up (e.g., apply power to antenna resources that was reduced or terminated during a sleep duration) for each SSBS occasion (nominally 20 ms apart). This can limit the sleep duration, and thus power efficiency, of the UE. In turn, this limits the sleep mode that can be used, which can negatively impact connected discontinuous receive (CDRX) configurations for the UE. During mobility, the UE can sweep multiple beams in order to track the strongest or most desirable beam in a configured beam set, as described. Measuring multiple beams per SSBS can improve performance, which may be beneficial in orientations where UE does not have an antenna panel, as such areas may be covered by beams without any coverage.

Aspects described herein relate to using signals in a SSBS for performing beam sweeping. For example, upon each loop occasion, the receiving UE can apply serving UE beam on one or more symbols (e.g., on PBCH symbols—two symbols in total) having serving SSB in serving cell's SSBS (e.g., for performing loop tracking), and the receiving UE can apply a non-serving UE beam on one or more other symbols (e.g., SSS symbol) of serving SSB in serving cell's SSBS upon loop occasion. In this example, beam sweeping (e.g., for mobility tracking) can be performed using the SSB signals that are also used for loop processing.

In an example, using the SSB signals that are used for loop tracking to also perform beam sweeping can allow for decreasing or eliminating performing of independent beam sweeping procedures. This, in turn, can allow for additional sleep durations or sleep modes for a UE, which can conserve power used by the UE and result in improved battery life and performance.

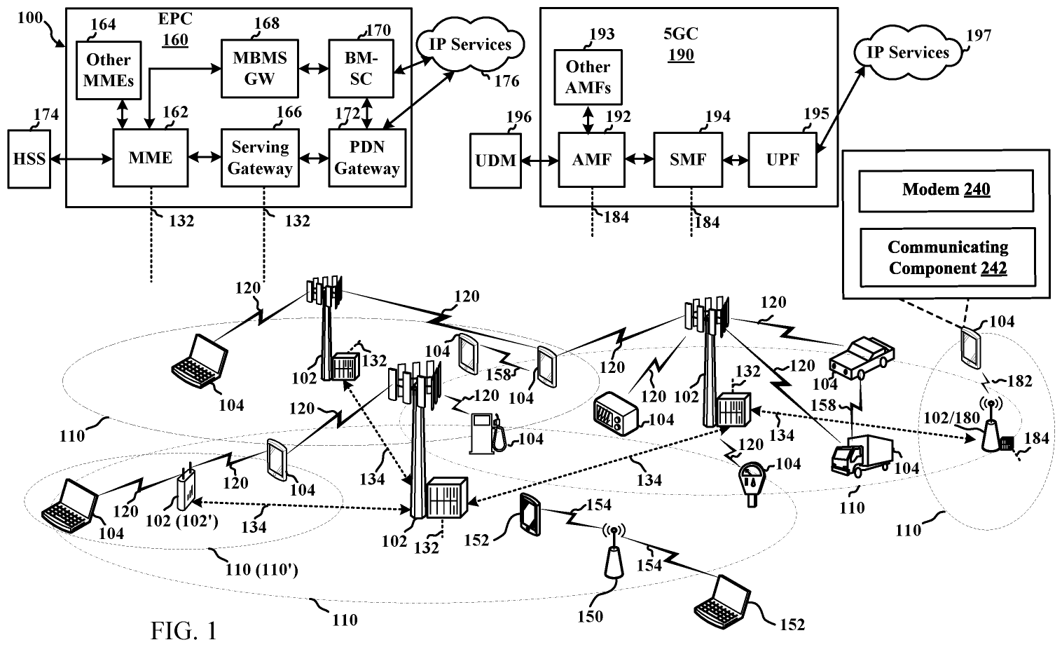

The described features will be presented in more detail below with reference to FIGS. 1-5.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system, such as a UE 104, may have a modem 240 and communicating component 242 for using signals for loop processing additionally for beam sweeping, in accordance with aspects described herein. Though a UE 104 is shown as having the modem 240 and communicating component 242, this is one illustrative example, and substantially any node or type of node may include a modem 240 and communicating component 242 for providing corresponding functionalities described herein.

The base stations 102 configured for 4G LTE (which can collectively be referred to as Evolved Universal Mobile Telecommunications System (UMTS) Terrestrial Radio

Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, communicating component 242 of a UE 104 can receive a SSBS from a base station 102 for performing loop processing. As part of receiving the SSBS, for example, communicating component 242 can use a serving beam at the UE 104 for receiving one or more of the signals in the SSBS while using a non-serving beam at the UE 104 for receiving one or more other signals in the SSBS. For example, communicating component 242 can receive the PBCH signals using the serving beam and can receive the SSS using the non-serving beam. In an example, communicating component 242 can measure one or more metrics of the SSS based on the non-serving beam, such as a signal power or quality, and can perform one or more other functions based on the measured metric(s). In one example, communicating component 242 can perform mobility tracking based on the measurement metric(s) of the signal using the non-serving beam. In addition, in an example, communicating component 242 can measure one or more metrics of other signals in other SSBSs (e.g., other SSSs in subsequent SSBS(s)) using other non-serving beams in a configured beam set to determine whether to switch the serving beam in mobility tracking.

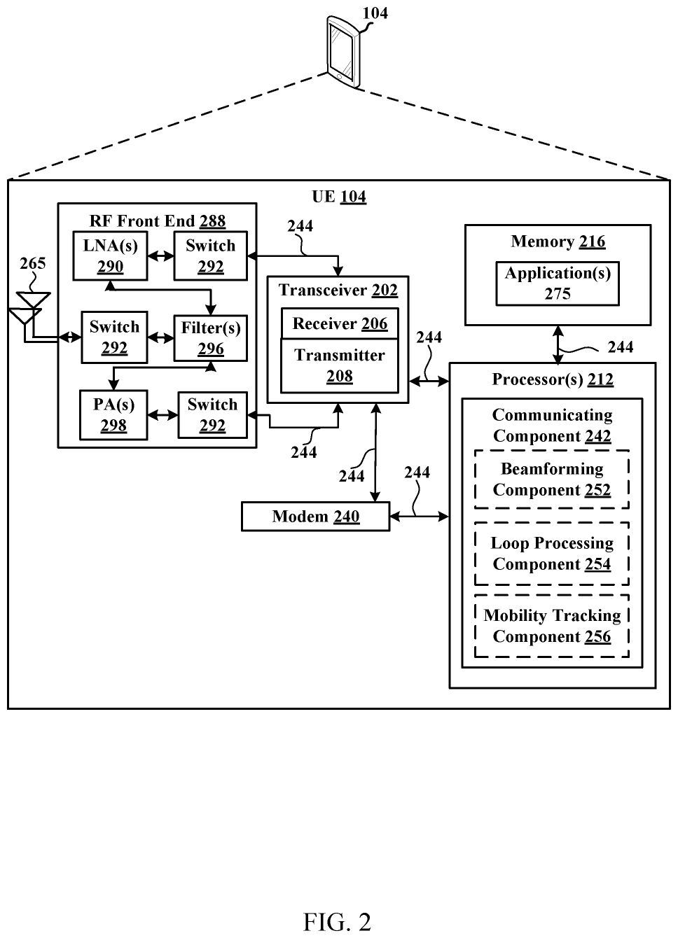

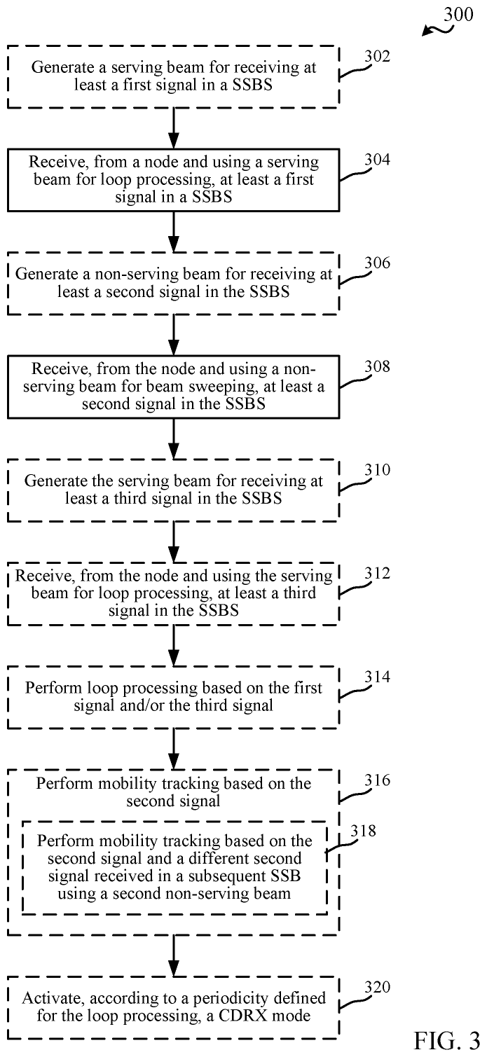

Turning now to FIGS. 2-5, aspects are depicted with reference to one or more components and one or more methods that may perform the actions or operations described herein, where aspects in dashed line may be optional. Although the operations described below in FIG. 3 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 for wireless communications is illustrated. UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 for using signals for loop processing additionally for beam sweeping, in accordance with aspects described herein.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), reference signal received quality (RSRQ), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with one or more other nodes, for example, one or more base stations 102 or one or more cells associated with one or more base stations 102, one or more other UEs 104, etc. In an aspect, for example, modem 240 can configure transceiver 202 to operate at a specified frequency and power level based on the configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on configuration information associated with UE 104 as provided by the network during cell selection and/or cell reselection.

In an aspect, communicating component 242 can optionally include a beamforming component 252 for generating one or more beams for receiving signals in a SSBS, a loop processing component 254 for processing one or more loops based on a received SSBS signal, such as a TTL, FTL, or AGC loop, and/or a mobility tracking component 256 for performing mobility tracking using one or more non-serving beams to receive signals in the SSBS, in accordance with aspects described herein.

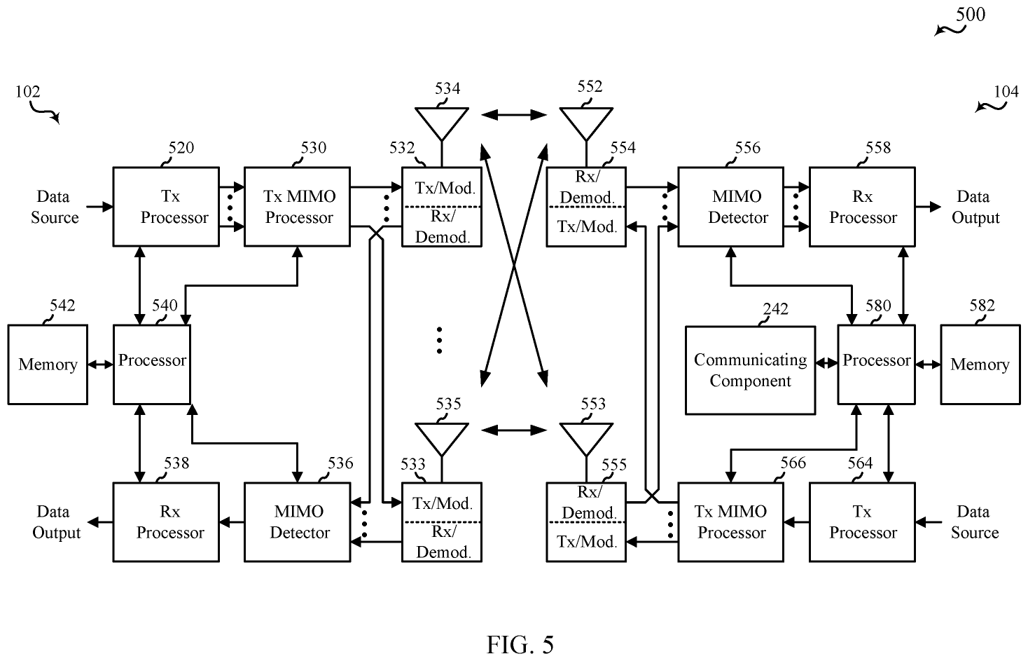

In an aspect, the processor(s) 212 may correspond to one or more of the processors described in connection with the UE in FIG. 5. Similarly, the memory 216 may correspond to the memory described in connection with the UE in FIG. 5.

FIG. 3 illustrates a flow chart of an example of a method 300 for using beams received for loop processing also for performing beam sweeping, in accordance with aspects described herein. In an example, a UE 104 can perform the functions described in method 300 using one or more of the components described in FIGS. 1 and 2.

In method 300, optionally at Block 302, a serving beam for receiving at least a first signal in a SSBS can be generated. In an aspect, beamforming component 252, e.g., in conjunction with processor(s) 212, memory 216, transceiver 202, communicating component 242, etc., can generate the serving beam for receiving at least the first signal in the SSBS. For example, beamforming component 252, as described, can selectively enable or apply power to certain antenna resources (e.g., certain antennas in an antenna array, certain other antenna elements, etc.) to achieve a spatial direction for a receiver beam. In an example, the serving beam can be one of multiple beams configured in a beam set for the UE 104, where the beam set includes multiple beams that the UE 104 can use to communicate with a base station 102 or other device. In one example, the base station 102 can configure the beams for the UE 104 based on capability information of the UE 104, radio environment, parameters measured by the base station 102, and/or the like. In an example, the serving beam may be configured by the base station 102 or determined by the UE 104 and notified to the base station 102, which may impact the beam used by the base station 102 to transmit the first signal.

In method 300, at Block 304, at least a first signal in a SSBS can be received from a node and using a serving beam for loop processing. In an aspect, communicating component 242, e.g., in conjunction with processor(s) 212, memory 216, transceiver 202, etc., can receive, from the node (e.g., from a base station 102 or other transmitting device) and using a serving beam for loop processing (e.g., as generated by beamforming component 252, as described above), at least the first signal in the SSBS. In an example, the first signal in the SSBS may include a PSS or PBCH signal, which communicating component 242 can receive using the serving beam.

In an example, the SSBS may be configured at a periodicity for transmission by the base station 102, where the periodicity can be defined in a wireless communication standard, such as 5G, or otherwise indicated or configured by the base station 102. In one specific example, the base station 102 can transmit SSBSs at a 20 ms periodicity, and the UE 104 can attempt to receive each SSBS or a portion of the SSBSs for various purposes. In one example, the UE 104 can attempt to receive an SSBS for the purpose of loop tracking for a TTL, FTL, or AGC loop, which may be according to a second periodicity that may be a multiple of the SSBS periodicity (e.g., 80 ms or 160 ms). In one specific example, the UE 104 may enter CDRX mode and may, during a sleep duration, selectively reduce or terminate power to antenna resources to conserve energy. When in CDRX mode, the UE 104 can wake up, which may include applying power back to the antenna resources, to receive the SSBSs at least for loop processing.

In method 300, optionally at Block 306, a non-serving beam for receiving at least a second signal in the SSBS can be generated. In an aspect, beamforming component 252, e.g., in conjunction with processor(s) 212, memory 216, transceiver 202, communicating component 242, etc., can generate the non-serving beam for receiving at least the second signal in the SSBS. For example, the non-serving beam can be one of the multiple beams configured in a beam set for the UE 104, where the beam set includes multiple beams that the UE 104 can use to communicate with a base station 102 or other device. As described, the UE 104 can be configured to perform a beam sweeping process of using the multiple beams in the beam set to determine an optimal beam for communicating with the base station 102, where the optimal beam can be one resulting in receiving signals with a most desirable power or quality metric (e.g., SINR, RSRP, RSRQ, RSSI, etc.). Using a non-serving beam to receive a signal in the SSBS, however, can mitigate, or at least decrease, time used in performing the beam sweeping, as described further herein.

In method 300, at Block 308, at least a second signal in the SSBS can be received from the node and using a non-serving beam for beam sweeping. In an aspect, communicating component 242, e.g., in conjunction with processor(s) 212, memory 216, transceiver 202, etc., can receive, from the node (e.g., from a base station 102 or other transmitting device) and using a non-serving beam for beam sweeping (e.g., as generated by beamforming component 252, as described above), at least the second signal in the SSBS. In an example, the second signal in the SSBS may include a SSS, which communicating component 242 can receive using the non-serving beam.

In method 300, optionally at Block 310, the serving beam for receiving at least a third signal in the SSBS can be generated. In an aspect, beamforming component 252, e.g., in conjunction with processor(s) 212, memory 216, transceiver 202, communicating component 242, etc., can generate the serving beam for receiving at least the third signal in the SSBS. For example, the serving beam can be used for the third signal to receive the third signal for loop processing.

In method 300, optionally at Block 312, at least a third signal in the SSBS can be received from the node and using the serving beam. In an aspect, communicating component 242, e.g., in conjunction with processor(s) 212, memory 216, transceiver 202, etc., can receive, from the node (e.g., from a base station 102 or other transmitting device) and using the serving beam (e.g., as generated by beamforming component 252, as described above), at least the third signal in the SSBS. In an example, the third signal in the SSBS may include a PBCH, which communicating component 242 can receive using the serving beam for performing loop processing along with the previously received PBCH.

In method 300, optionally at Block 314, loop processing can be performed based on the first signal and/or the third signal. In an aspect, loop processing component 254, e.g., in conjunction with processor(s) 212, memory 216, transceiver 202, communicating component 242, etc., can perform loop processing based on the first signal and/or the third signal (e.g., where the third signal is received and/or is received using the serving beam). For example, loop processing component 254 can maintain a TTL, FTL, or AGC loop based on observed properties of the PBCH signal, such as a time at which the PBCH signal is received, a frequency at which the PBCH signal is received, a power or quality at which the PBCH signal is received, etc. As described, for example, loop processing component 254 can perform the loop processing, and/or can receive the SSBS for the purpose of loop processing, based on a periodicity that is greater than the periodicity at which the SSBS is transmitted. This can conserve resources at the UE 104, as loop processing may not need to be performed each time SSBS is transmitted by the base station 102. In addition, this may allow the UE 104 to enter CDRX mode to institute, between loop processing periods, a sleep duration during which signals are not received, and thus less power can be used by the UE 104 antenna elements.

In method 300, optionally at Block 316, mobility tracking can be performed based on the second. In an aspect, mobility tracking component 256, e.g., in conjunction with processor(s) 212, memory 216, transceiver 202, communicating component 242, etc., can perform mobility tracking based on the second signal. For example, mobility tracking component 256 can perform mobility tracking based on comparing one or more metrics of the second signal, as received using the non-serving beam, to one or more metrics of the first or third signal received using the serving beam, and/or of other signals received using the serving beam or other non-serving beams, as described further herein. Where the second signal has more desirable values for the one or more metrics, for example, mobility tracking component 256 can switch the serving beam to the non-serving beam used to receive the second signal. In this regard, for example, beamforming component 252 can beamform to the new serving beam in receiving subsequent signals (e.g., subsequent SSBS signals or at least the PBCH signals, etc.).

In one example, mobility tracking component 256 can perform mobility tracking over multiple SSBSs based on receiving a fourth signal using a second non-serving beam. For example, beamforming component 252 can beamform using the serving beam to receive the first and/or third signals in two SSBSs, but can beamform using different non-serving beams to receive the second signal in each SSBS. In this example, mobility tracking component 256 can additionally or alternatively compare metrics of the two second signals from the different SSBSs in determining whether to switch to a new serving beam. Thus, in an example, in performing mobility tracking at Block 316, optionally at Block 318, mobility tracking can be performed based on the second signal and a different signal received in a subsequent SSB using a second non-serving beam. In an aspect, mobility tracking component 256, e.g., in conjunction with processor(s) 212, memory 216, transceiver 202, communicating component 242, etc., can perform mobility tracking based on the second signal and the different second signal received in the subsequent SSB using the second non-serving beam, as described above. For example, mobility tracking component 256 can compare metrics of the second signal, the different second signal, and/or the first or third signal, and can determine whether to select a new serving beam based on comparing the metrics.

As described, for example, using the loop processing signals to also perform mobility tracking can reduce the time needed for mobility tracking and/or eliminate a separate mobility tracking procedure. In one example, by measuring multiple UE beams simultaneously, the UE can spend more time in sleep modes and save power in CDRX mode. In another example, this can allow for tracking multiple beams in one SSBS opportunity, which can improve beam tracking in mobility scenarios. For example, if a most likely non-serving beam is selected, this may result in faster resolution of whether a new serving beam is to be used in mobility tracking without having to measure additional non-serving beams. As fewer SSBS opportunities are needed for the UE to track beams, power consumption savings can also occur by reducing measurement opportunities used in slow motion scenarios.

In method 300, optionally at Block 320, a CDRX mode can be activated according to a periodicity defined for the loop processing. In an aspect, loop processing component 254, e.g., in conjunction with processor(s) 212, memory 216, transceiver 202, communicating component 242, etc., can activate, according to a periodicity defined for the loop processing, the CDRX mode. For example, loop processing component 254 can activate the CDRX mode to start a sleep duration for a period of time according to the periodicity. When the sleep duration is completed, for example, loop processing component 254 can apply power to antenna resources to receive signals in a SSBS according to a serving beam (and/or a non-serving beam), as described above. In one example, receiving the first signal at Block 304 and the second signal at Block 308 may be performed after the sleep duration when the UE 104 is in active mode. In addition, for example, the CDRX mode periodicity for activating the CDRX mode can be greater than the periodicity defined for the loop processing, such to further conserve power at the UE 104 by not performing loop processing at each loop processing opportunity.

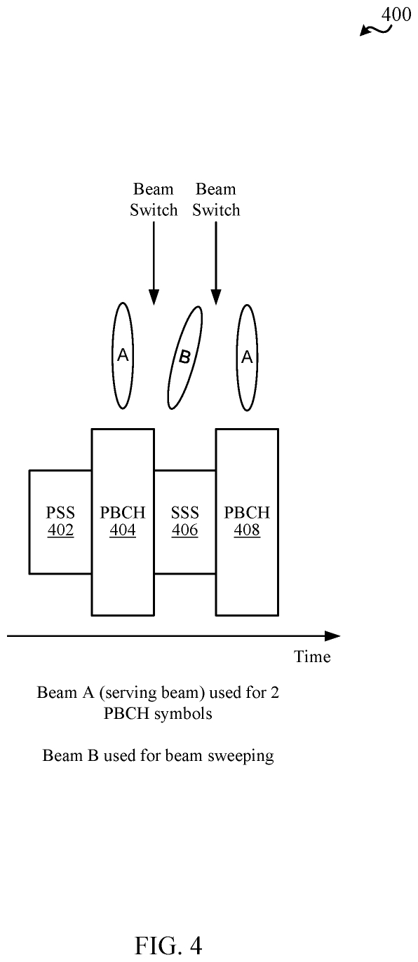

FIG. 4 illustrates an example of a timeline 400 for receiving a S SB S. The SSBS can include a PSS 402, PBCH 404, SSS 406, and PBCH 408. In one example, a base station 102 can transmit the SSBS according to a defined periodicity (e.g., every 20 ms). For example, as described, the UE 104 can receive, from the base station 102, the PBCH 404 based on serving beam A. In one example, this serving beam A can be a last serving beam used to communicate with the base station 102. In another example, the PSS 402 may include information for determining the serving beam A. In any case, the UE 104 can switch to a non-serving beam B to receive the SSS 406, where the non-serving beam B may be part of a beam set configured at the UE 104 for performing mobility tracking. The UE 104 can then switch back to the serving beam A to receive PBCH 408. The UE 104 can perform loop processing based at least on the received PBCHs 404, 408. The UE 104 can process the received SSS 406 using a beam sweeping procedure, such as for mobility tracking, as described herein. For example, the UE 104 can compare received signal power or quality metrics of the received SSS 406 with other received SSSs using other non-serving beams, with the PBCH(s) 404, 408 using the serving beam, etc. to determine whether a new serving beam is to be configured.

FIG. 5 is a block diagram of a MIMO communication system 500 including a base station 102 and a UE 104. The MIMO communication system 500 may illustrate aspects of the wireless communication access network 100 described with reference to FIG. 1. The base station 102 may be an example of aspects of the base station 102 described with reference to FIG. 1. The base station 102 may be equipped with antennas 534 and 535, and the UE 104 may be equipped with antennas 552 and 553. In the MIMO communication system 500, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 520 may receive data from a data source. The transmit processor 520 may process the data. The transmit processor 520 may also generate control symbols or reference symbols. A transmit MIMO processor 530 may perform spatial processing (e.g., precoding) on data symbols, control symbols, or reference symbols, if applicable, and may provide output symbol streams to the transmit modulator/demodulators 532 and 533. Each modulator/demodulator 532 through 533 may process a respective output symbol stream (e.g., for OFDM, etc.) to obtain an output sample stream. Each modulator/demodulator 532 through 533 may further process (e.g., convert to analog, amplify, filter, and upconvert) the output sample stream to obtain a DL signal. In one example, DL signals from modulator/demodulators 532 and 533 may be transmitted via the antennas 534 and 535, respectively.

The UE 104 may be an example of aspects of the UEs 104 described with reference to FIGS. 1-2. At the UE 104, the UE antennas 552 and 553 may receive the DL signals from the base station 102 and may provide the received signals to the modulator/demodulators 554 and 555, respectively. Each modulator/demodulator 554 through 555 may condition (e.g., filter, amplify, downconvert, and digitize) a respective received signal to obtain input samples. Each modulator/demodulator 554 through 555 may further process the input samples (e.g., for OFDM, etc.) to obtain received symbols. A MIMO detector 556 may obtain received symbols from the modulator/demodulators 554 and 555, perform MIMO detection on the received symbols, if applicable, and provide detected symbols. A receive (Rx) processor 558 may process (e.g., demodulate, deinterleave, and decode) the detected symbols, providing decoded data for the UE 104 to a data output, and provide decoded control information to a processor 580, or memory 582.

The processor 580 may in some cases execute stored instructions to instantiate a communicating component 242 (see e.g., FIGS. 1 and 2).

On the uplink (UL), at the UE 104, a transmit processor 564 may receive and process data from a data source. The transmit processor 564 may also generate reference symbols for a reference signal. The symbols from the transmit processor 564 may be precoded by a transmit MIMO processor 566 if applicable, further processed by the modulator/demodulators 554 and 555 (e.g., for SC-FDMA, etc.), and be transmitted to the base station 102 in accordance with the communication parameters received from the base station 102. At the base station 102, the UL signals from the UE 104 may be received by the antennas 534 and 535, processed by the modulator/demodulators 532 and 533, detected by a MIMO detector 536 if applicable, and further processed by a receive processor 538. The receive processor 538 may provide decoded data to a data output and to the processor 540 or memory 542.

The components of the UE 104 may, individually or collectively, be implemented with one or more ASICs adapted to perform some or all of the applicable functions in hardware. Each of the noted modules may be a means for performing one or more functions related to operation of the MIMO communication system 500. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 500.

The following aspects are illustrative only and aspects thereof may be combined with aspects of other embodiments or teaching described herein, without limitation.

Aspect 1 is a method for wireless communication at a UE that includes receiving, from a node and using a serving beam for loop processing, at least a first signal in a synchronization signal burst set, and receiving, from the node and using a non-serving beam for beam sweeping, at least a second signal in the synchronization signal burst set.

In Aspect 2, the method of Aspect 1 includes where at least the first signal includes a PBCH signal in the synchronization signal burst set, and at least the second signal includes a SSS in the synchronization signal burst set.

In Aspect 3, the method of Aspect 2 includes where receiving at least the first signal includes receiving, using the serving beam, the PBCH signal before receiving the SSS, and receiving, using the serving beam, a second PBCH signal in the synchronization signal burst set after receiving the SSS.

In Aspect 4, the method of Aspect 3 includes performing processing of at least one of a time tracking loop, a frequency tracking loop, or an automatic gain control based at least in part on the PBCH signal and the second PBCH signal.

In Aspect 5, the method of any of Aspects 1 to 4 includes receiving, from the node and using the serving beam for loop processing, at least a third signal in a subsequent synchronization signal burst set according to a periodicity for the loop processing, receiving, from the node and using a second non-serving beam for the beam sweeping, at least a fourth signal in the subsequent synchronization signal burst set, and selecting a new serving beam for communicating with the node, as one of the non-serving beam or the second non-serving beam, based on performing signal measurements of at least the second signal and at least the fourth signal.

In Aspect 6, the method of any of Aspects 1 to 5 includes activating, according to a periodicity defined for the loop processing, a CDRX mode, wherein receiving at least the first signal and the second signal in the synchronization signal burst set is during the CDRX mode.

In Aspect 7, the method of Aspect 6 includes where a CDRX mode periodicity for activating the CDRX mode is greater than the periodicity defined for the loop processing.

In Aspect 8, the method of any of Aspects 1 to 7 includes receiving, from the node and using one or more other non-serving beams, one or more other signals based on a periodicity for the beam sweeping, and selecting a new serving beam for communicating with the node, as one of the non-serving beam or the one or more other non-serving beams, based on performing signal measurements of at least the second signal and the one or more other signals.

Aspect 9 is an apparatus for wireless communication including a transceiver, a memory configured to store instructions, and one or more processors communicatively coupled with the memory and the transceiver, where the one or more processors are configured to execute the instructions to cause the apparatus to perform any of the methods of Aspects 1 to 8.

Aspect 10 is an apparatus for wireless communication including means for performing any of the methods of Aspects 1 to 8.

Aspect 11 is a computer-readable medium including code executable by one or more processors for wireless communications, the code including code for performing any of the methods of Aspects 1 to 8.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
receive, from a node and using a serving beam for loop processing, at least a first signal in a synchronization signal burst set; and
receive, from the node and using a non-serving beam for beam sweeping, at least a second signal in the synchronization signal burst set.

2. The apparatus of claim 1, wherein at least the first signal includes a physical broadcast channel (PBCH) signal in the synchronization signal burst set, and wherein at least the second signal includes a secondary synchronization signal (SSS) in the synchronization signal burst set.

3. The apparatus of claim 2, wherein the one or more processors are configured to receive at least the first signal using the serving beam as the PBCH signal before receiving the SSS, and wherein the one or more processors are further configured to receive, using the serving beam, a second PBCH signal in the synchronization signal burst set after receiving the SSS.

4. The apparatus of claim 3, wherein the one or more processors are further configured to perform processing of at least one of a time tracking loop, a frequency tracking loop, or an automatic gain control based at least in part on the PBCH signal and the second PBCH signal.

5. The apparatus of claim 1, wherein the one or more processors are further configured to:
receive, from the node and using the serving beam for loop processing, at least a third signal in a subsequent synchronization signal burst set according to a periodicity for the loop processing;
receive, from the node and using a second non-serving beam for the beam sweeping, at least a fourth signal in the subsequent synchronization signal burst set; and
select a new serving beam for communicating with the node, as one of the non-serving beam or the second non-serving beam, based on performing signal measurements of at least the second signal and at least the fourth signal.

6. The apparatus of claim 1, wherein the one or more processors are further configured to activate, according to a periodicity defined for the loop processing, a connected discontinuous receive (CDRX) mode, wherein the one or more processors are configured to receive at least the first signal and the second signal in the synchronization signal burst set during the CDRX mode.

7. The apparatus of claim 6, wherein a CDRX mode periodicity for activating the CDRX mode is greater than the periodicity defined for the loop processing.

8. The apparatus of claim 1, wherein the one or more processors are further configured to:
receive, from the node and using one or more other non-serving beams, one or more other signals based on a periodicity for the beam sweeping; and
select a new serving beam for communicating with the node, as one of the non-serving beam or the one or more other non-serving beams, based on performing signal measurements of at least the second signal and the one or more other signals.

9. A method for wireless communication at a user equipment (UE), comprising:
receiving, from a node and using a serving beam for loop processing, at least a first signal in a synchronization signal burst set; and
receiving, from the node and using a non-serving beam for beam sweeping, at least a second signal in the synchronization signal burst set.

10. The method of claim 9, wherein at least the first signal includes a physical broadcast channel (PBCH) signal in the synchronization signal burst set, and wherein at least the second signal includes a secondary synchronization signal (SSS) in the synchronization signal burst set.

11. The method of claim 10, wherein receiving at least the first signal includes receiving, using the serving beam, the PBCH signal before receiving the SSS, and further comprising receiving, using the serving beam, a second PBCH signal in the synchronization signal burst set after receiving the SSS.

12. The method of claim 11, further comprising performing processing of at least one of a time tracking loop, a frequency tracking loop, or an automatic gain control based at least in part on the PBCH signal and the second PBCH signal.

13. The method of claim 9, further comprising:
receiving, from the node and using the serving beam for loop processing, at least a third signal in a subsequent synchronization signal burst set according to a periodicity for the loop processing;
receiving, from the node and using a second non-serving beam for the beam sweeping, at least a fourth signal in the subsequent synchronization signal burst set; and
selecting a new serving beam for communicating with the node, as one of the non-serving beam or the second non-serving beam, based on performing signal measurements of at least the second signal and at least the fourth signal.

14. The method of claim 9, further comprising activating, according to a periodicity defined for the loop processing, a connected discontinuous receive (CDRX) mode, wherein receiving at least the first signal and the second signal in the synchronization signal burst set is during the CDRX mode.

15. The method of claim 14, wherein a CDRX mode periodicity for activating the CDRX mode is greater than the periodicity defined for the loop processing.

16. The method of claim 9, further comprising:
receiving, from the node and using one or more other non-serving beams, one or more other signals based on a periodicity for the beam sweeping; and
selecting a new serving beam for communicating with the node, as one of the non-serving beam or the one or more other non-serving beams, based on performing signal measurements of at least the second signal and the one or more other signals.

17. An apparatus for wireless communication, comprising:
means for receiving, from a node and using a serving beam for loop processing, at least a first signal in a synchronization signal burst set; and
means for receiving, from the node and using a non-serving beam for beam sweeping, at least a second signal in the synchronization signal burst set.

18. The apparatus of claim 17, wherein at least the first signal includes a physical broadcast channel (PBCH) signal in the synchronization signal burst set, and wherein at least the second signal includes a secondary synchronization signal (SSS) in the synchronization signal burst set.

19. The apparatus of claim 18, wherein the means for receiving at least the first signal receives, using the serving beam, the PBCH signal before receiving the SSS, and further comprising means for receiving, using the serving beam, a second PBCH signal in the synchronization signal burst set after receiving the SSS.

20. The apparatus of claim 19, further comprising means for performing processing of at least one of a time tracking loop, a frequency tracking loop, or an automatic gain control based at least in part on the PBCH signal and the second PBCH signal.

21. The apparatus of claim 17, further comprising:
means for receiving, from the node and using the serving beam for loop processing, at least a third signal in a subsequent synchronization signal burst set according to a periodicity for the loop processing;
means for receiving, from the node and using a second non-serving beam for the beam sweeping, at least a fourth signal in the subsequent synchronization signal burst set; and
means for selecting a new serving beam for communicating with the node, as one of the non-serving beam or the second non-serving beam, based on performing signal measurements of at least the second signal and at least the fourth signal.

22. The apparatus of claim 17, further comprising means for activating, according to a periodicity defined for the loop processing, a connected discontinuous receive (CDRX) mode, wherein the means for receiving at least the first signal and the second signal in the synchronization signal burst set receive during the CDRX mode.

23. The apparatus of claim 17, further comprising:
means for receiving, from the node and using one or more other non-serving beams, one or more other signals based on a periodicity for the beam sweeping; and
means for selecting a new serving beam for communicating with the node, as one of the non-serving beam or the one or more other non-serving beams, based on performing signal measurements of at least the second signal and the one or more other signals.

24. A computer-readable medium comprising code executable by one or more processors for wireless communications at a user equipment (UE), the code comprising code for:
receiving, from a node and using a serving beam for loop processing, at least a first signal in a synchronization signal burst set; and
receiving, from the node and using a non-serving beam for beam sweeping, at least a second signal in the synchronization signal burst set.

25. The computer-readable medium of claim 24, wherein at least the first signal includes a physical broadcast channel (PBCH) signal in the synchronization signal burst set, and wherein at least the second signal includes a secondary synchronization signal (SSS) in the synchronization signal burst set.

26. The computer-readable medium of claim 25, wherein the code for receiving at least the first signal receives, using the serving beam, the PBCH signal before receiving the SSS, and further comprising code for receiving, using the serving beam, a second PBCH signal in the synchronization signal burst set after receiving the SSS.

27. The computer-readable medium of claim 26, further comprising code for performing processing of at least one of a time tracking loop, a frequency tracking loop, or an automatic gain control based at least in part on the PBCH signal and the second PBCH signal.

28. The computer-readable medium of claim 24, further comprising:
code for receiving, from the node and using the serving beam for loop processing, at least a third signal in a subsequent synchronization signal burst set according to a periodicity for the loop processing;
code for receiving, from the node and using a second non-serving beam for the beam sweeping, at least a fourth signal in the subsequent synchronization signal burst set; and
code for selecting a new serving beam for communicating with the node, as one of the non-serving beam or the second non-serving beam, based on performing signal measurements of at least the second signal and at least the fourth signal.

29. The computer-readable medium of claim 24, further comprising code for activating, according to a periodicity defined for the loop processing, a connected discontinuous receive (CDRX) mode, wherein the code for receiving at least the first signal and the second signal in the synchronization signal burst set receive during the CDRX mode.

30. The computer-readable medium of claim 24, further comprising:
code for receiving, from the node and using one or more other non-serving beams, one or more other signals based on a periodicity for the beam sweeping; and
code for selecting a new serving beam for communicating with the node, as one of the non-serving beam or the one or more other non-serving beams, based on performing signal measurements of at least the second signal and the one or more other signals.
